(19) United States
(12) Patent Application Publication
(10) Pub. No.: US 2018/0011913 A1
(43) Pub. Date: Jan. 11, 2018

(54) DATA REPLICATION MANAGEMENT

(71) Applicant: HEWLETT PACKARD ENTERPRISE DEVELOPMENT LP, Houston, TX (US)

(72) Inventors: Sri Harshan Kapanipathi, Bangalore (IN); Deepak Vasudevan, Bangalore (IN); Deven Mahendraray Thaker, Bangalore (IN)

(21) Appl. No.: 15/542,963

(22) PCT Filed: Sep. 18, 2015
(86) PCT No.: PCT/US2015/050867

§ 371 Date: Jul. 12, 2017

(30) Foreign Application Priority Data
Jun. 9, 2015 (IN) 2885/CHE/2015

(51) Int. Cl. G06F 17/30

(52) U.S. Cl. CPC G06F 17/30578

(57) ABSTRACT

In one example, initiating data replication process to copy source data set as target data sets to a plurality of target devices during a predefined time period, determining progress information regarding completion of the replication process based on historical and current performance information of the plurality of target devices, and if the progress information indicates that the replication process is not to be completed within a predefined time period, then selecting a target device from the plurality of target devices to complete the complete the replication process based on historical and current performance information of the plurality of target devices, and causing the selected target device to continue with the completion of the replication process, causing the non-selected target devices to discontinue with the replication process, and causing the replicated target data set to be copied to another target device of the plurality of target devices.

### BACKGROUND

Computer systems include computing devices that communicate with other computing devices over a network. The computing devices may include storage devices to store data for later retrieval. The computing devices may copy data from one computing device to other computing devices.

### BRIEF DESCRIPTION OF THE DRAWINGS

Examples are described in the following detailed description and in reference to the drawings, in which:

FIG. 1 depicts an example system for data replication management in accordance with an example of the techniques of the present application;

FIG. 2 depicts an example flow chart of processes for data replication management in accordance with an example of the techniques of the present application;

FIGS. 3A through 3B depict example diagrams of data replication management in accordance with an example of the techniques of the present application; and

FIG. 4 depicts an example block diagram showing a non-transitory, computer-readable medium that stores instructions for data replication management in accordance with an example of the techniques of the present application.

### DETAILED DESCRIPTION

Computer systems include computing devices that communicate with other computing devices over a network. The computing devices may include storage devices to store data for later retrieval. The computing devices may copy data from one computing device to other computing devices.

Computer system environments may implement data replication techniques to copy data from one computing device to another computing device for data availability purposes. For example, a source computing device may implement a data replication process to copy or replicate data to a plurality of target computing devices to provide a backup for data availability purposes. For example, in the event that one of the computing devices encounter an error condition such that the data may no longer be available, then a copy of the data may be retrieved from one of the other target computing devices. Computer system environments may be required to manage increased amounts of data including data volumes of unstructured data. In addition, computer systems may be configured as virtualization and cloud infrastructures to meet ever increasing resource demands. The computing devices may implement data replication techniques to provide high data availability. In one example, the computing devices may be configured to implement data replication techniques where copies are made to a plurality of target computing devices located across different locations or sites. However, data replication in such a configuration may encounter problems such as resource constraints or increases in data volume activity, such that the data replication process may not makes copies in a timely manner which may result in some targets not having copies.

The present application discloses techniques to provide data replication management techniques which may improve data replication from a source computing device to across a plurality of target computing devices which may increase the performance of the system. For example, the data replication techniques provide at least one copy of data to a target computing device to help ensure data availability even during resource constraint conditions such as bandwidth or data throughput constraints.

In one example of the present techniques, disclosed is a data replication management module configured to initiate a data replication process to copy a source data set as target data sets to a plurality of target computing devices during a predefined time period. The management module may determine progress information regarding completion of the data replication process based on historical and current performance information of the plurality of target computing devices.

If the data replication management module determines that the progress information indicates that the data replication process is not to be completed within the predefined time period, then the management module may select a target computing device from the plurality of target computing devices to complete the complete the data replication process based on historical and current performance information of the plurality of target computing devices. In one example, the data replication management module selects the target computing device that has highest performance compared to those of the other target computing devices. In this case, the management module may send a continue notification to the selected target computing device to cause the selected target computing device to continue with the completion of the data replication process. The management module may send a discontinue notification to non-selected target computing devices to cause the non-selected target computing devices to discontinue with the data replication process. The management module may cause the selected target computing device to initiate a data replication process to copy the replicated target data set to another target computing device of the plurality of target computing devices.

On the other hand, if the data replication management module determines that the progress information indicates that the data replication process is to be completed within the predefined time period, then the module may send continue notifications to the target computing devices to cause the target computing device to continue with the completion of the data replication process.

In another example, the data replication management module may be configured to calculate the current performance information of a target computing device which relates to data throughput during the data replication process and calculate the historical performance information of the target computing device which relates to data throughput during previous data replication processes. In another example, the management module may be configured to release processing resources used by the computing device associated with the non-selected target computing devices for use by the computing device for the data replication process of the selected target computing device. In this manner, releasing resources may allow the computing device to use the resources to complete the data replication process with the selected target computing device. In another example, management module may be configured to receive from a host computer a request to initiate the data replication process.

In this manner, the present application discloses techniques to provide data replication management techniques which may help improve data replication from a source computing device to across a plurality of target computing devices which may increase the performance of the system. For example, the data replication techniques such that even during resource constraint at least one copy of data is made to help ensure data availability.

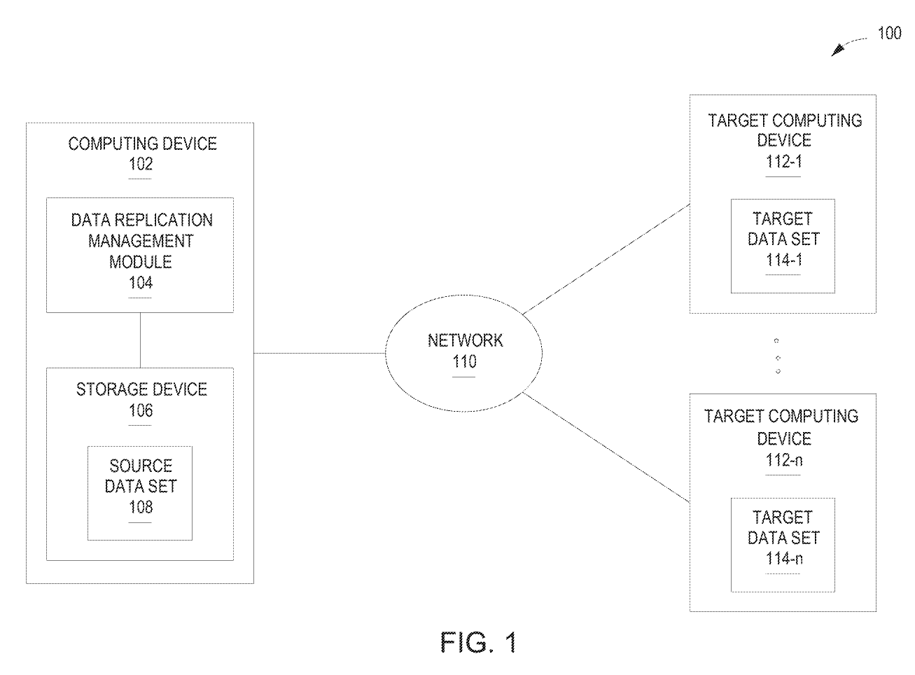

FIG. 1 depicts an example system 100 for data replication management in accordance with an example of the techniques of the present application. The system 100 includes a computing device 102 configured to communicate with target computing devices 112 over a network 110.

The computing device 102 includes a data replication management module 104 and a storage device 106 to store a source data set 108. The data replication management module 104 is configured to manage a data replication process to replicate or copy the source data set 108 to target data sets 114 (114-1 through 114-n) of target computing devices 112 (112-1 through 112-n), as explained below in further detail.

The data replication management module 104 may be configured to initiate a data replication process to copy the source data set 108 as target data sets 114 to a plurality of target computing devices 112 during a predefined time period. The predefined time period may be based on system 100 criteria such as on the characteristics of the source data set 108 such as size of the data and the like. In one example, the time period may be a predefined replication time window which may be configured after a backup and during off production time. The management module 104 may determine progress information regarding completion of the replication process based on historical and current performance information of the plurality of target computing devices 112. In one example, historical performance information may be defined as performance related information or data of the target computing devices over the time period of the previous replication processes. In one example, current performance information may be defined as performance related information or data of the target computing devices over or during the time period of the current data replication process. In one example, progress information may be defined as to what extent the current data replication process is complete such that a copy of the source data set 108 is made to the target data sets 114. In another example, the replication module 104 may determine the prorated progress of the data replication process toward completion. In one example, performance information may include data throughput (such as in Megabits per second (Mbps)) which include the amount of data moved or transferred successfully from computing device 102 to a target computing device 112 in a given time period.

If data replication management module 104 determines that the progress information indicates that the data replication process is not to be completed within the predefined time period, then management module may select a target computing device 112 from the plurality of target computing devices 112 to complete the complete the data replication process based on historical and current performance information of the plurality of target computing devices. In one example, the data replication management module selects the target computing device that has highest performance compared to those of the other target computing devices. It should be understood that the data replication management module may select the target computing device based on other techniques. For example, selection techniques may be based a target computing device site preference, which may be set by a user, such as administrator of the system, based on a parameter such as backup consolidation. In other examples, selection techniques may be based on storage capacity of the target computing devices, target computing device capabilities such as high availability, target computing device uptime and the like. In this case, management module 104 may send a continue notification to the selected target computing device 112 to cause the selected target computing device to continue with the completion of the data replication process. The management module 104 may send a discontinue notification to non-selected target computing devices 112 to cause the non-selected target computing devices to discontinue with the data replication process. The management module 104 may cause the selected target computing device 112 to initiate a data replication process to copy the replicated target data set to another target computing device of the plurality of target computing devices.

The data replication management module 104 may check the progress of the data replication process using techniques such as polling the status, interrupt or any other like technique. The “continue” and “discontinue” notifications may comprise any means of notifications such as commands, messages according to particular protocols and the like. The notifications may include notifications to start the data replication process, to stop the process, to pause the process, to restart the process and the like. The source data set 108 may include a group of data blocks associated with particular applications such as file systems, databases and the like. The data replication process may include a process of copying from computing device 102 to target computing devices 112 data blocks in a successive manner one block after another until a complete copy is made as target data sets 114 to the target computing devices. In another example, the replication process may be based on deduplication based replication techniques (also known as low bandwidth replication) such that data that is not at the target is not transferred.

On the other hand, if data replication management module 104 determines that the progress information indicates that the data replication process is to be completed within the predefined time period, then the module may send continue notifications to the target computing devices 112 to cause the target computing device to continue with the completion of the data replication process.

In another example, data replication management module 104 may be configured to calculate the current performance information of a target computing device 112 which relates to data throughput during the data replication process and calculate the historical performance information of the target computing device which relates to data throughput during previous data replication processes. The performance information of computing devices 112 may be any performance metric, such as data throughput, related to processing data to transfer data across network 110. In another example, management module 104 may be configured to release processing resources used by the computing device associated with the non-selected target computing devices for use by the computing device for the data replication process of the selected target computing device. In one example, processing resources may any computing or processing resources for processing data associated with hardware, software or a combination thereof of the computing device. In another example, management module 104 may be configured to receive from a host computer a request to initiate the data replication process.

In another example, computing device 102 may be configured to provide storage management functionality as described herein. In one example, computing device 102 may provide functionality to process Input/Output (10) requests from host computers to access source data set 108 on storage device 106.

The storage device 106 may be defined as any electronic means to store data for later retrieval. The source data set 108 may be stored as storage volumes which may by logical units of data that can be defined across multiple storage devices. The 10 requests may include requests to read data from storage device 106 as volumes and requests to write data to the storage devices as volumes. The source data set 108 may be defined as a group of data or volumes to be replicated or copied from one computing device to another computing device. The computing device 102 and target computing devices 112 may include any electronic device or means of processing data. The storage device 106 may refer to a physical storage element, such as a disk-based storage element (e.g., hard disk drive, optical disk drive, etc.) or other type of storage element (e.g., semiconductor storage element). In one example, multiple storage devices within a storage subsystem can be arranged as an array configuration. The description of source data set 106 applies to the description of target data sets 114.

The network 110 may include any means of electronic or data communication between computing device 102 and target computing devices 112. The network 110 may include a local area network, Internet and the like. The network 110 may include Fibre Channel network, SCSI (Small Computer System Interface) link, Serial Attached SCSI (SAS) link and the like. The network 110 may include expanders, concentrators, routers, and other communications devices.

The system 100 of FIG. 1 shows example computing device 102 to communicate with target computing devices 112 and should be understood that other configurations may be employed to practice the techniques of the present application. For example, system 100 may be configured to include a plurality of computing devices 102 to communicate with a plurality of target computing devices 112. In another example, storage device 106 is shown as a single component but it should be understood that the storage device may be plurality of storage devices distributed across a plurality of computing devices 102. In another example, source data set 108 is shown as a single component but it should be understood that the source data set may be plurality of source data sets distributed across a plurality of computing devices 102. In another example, data replication management module 104 is shown as a single component but it should be understood that the module may be plurality of modules distributed across a plurality of computing devices 102. The components of system 100 may be implemented in hardware, software or a combination thereof. In one example, data replication management module 104 may be implemented in hardware, software or a combination thereof. In another example, the functionality of the components of system 100 may be implemented using technology related to Personal Computers (PCs), server computers, tablet computers, mobile computers and the like.

FIG. 1 shows a system 100 to provide data replication management. The storage system 100 may include computer-readable storage medium comprising (e.g., encoded with) instructions executable by a processor to implement functionalities described herein in relation to FIG. 1. In some examples, the functionalities described herein in relation to instructions to implement data replication management module 104 functions, and any additional instructions described herein in relation to storage medium, may be implemented as engines or modules comprising any combination of hardware and programming to implement the functionalities of the modules or engines, as described below. The functions of data replication management module 104 may be implemented by a computing device which may be a server, blade enclosure, desktop computer, laptop (or notebook) computer, workstation, tablet computer, mobile phone, smart device, or any other processing device or equipment including a processing resource. In examples described herein, a processor may include, for example, one processor or multiple processors included in a single computing device or distributed across multiple computing devices.

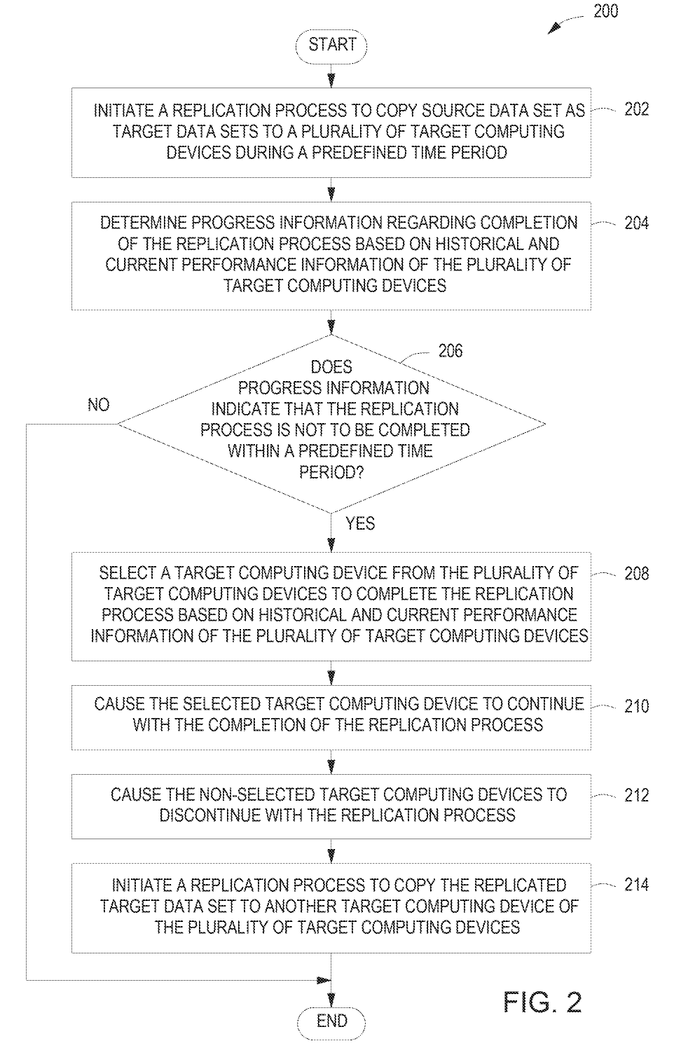

FIG. 2 depicts an example flow chart 200 of a process for data replication management in accordance with an example of the techniques of the present application. To illustrate operation, it may be assumed that system 100 includes computing device 102 configured to communicate with target computing devices 112 over network 110. The data replication management module 104 may be configured to implement the techniques of the present application and functionality described herein.

It should be understood the process depicted in FIG. 2 represents generalized illustrations, and that other processes may be added or existing processes may be removed, modified, or rearranged without departing from the scope and spirit of the present application. In addition, it should be understood that the processes may represent instructions stored on a computer-readable storage medium that, when executed, may cause a processor to respond, to perform actions, to change states, and/or to make decisions. Alternatively, the processes may represent functions and/or actions performed by functionally equivalent circuits like analog circuits, digital signal processing circuits, Application Specific Integrated Circuits (ASICs), or other hardware components associated with the system. Furthermore, the flow charts are not intended to limit the implementation of the present application, but rather the flow charts illustrate functional information to design/fabricate circuits, generate software, or use a combination of hardware and software to perform the illustrated processes.

The process 200 may begin at block 202, where data replication management module 104 initiates a data replication process to copy source data set 108 as target data sets 114 to a plurality of target computing devices 112 during a predefined time period. In one example, it may be assumed that a host computing device sent a notification such as a command to computing device 102 to initiate the data replication process. Processing proceeds to block 204.

At block 204, data replication management module 104 determines progress information regarding completion of the data replication process based on historical and current performance information of the plurality of target computing devices. Processing proceeds to block 206.

At block 206, data replication management module 104 checks progress information to determine whether the information indicates that the data replication process is not to be completed within a predefined time period. In one example, if data replication management module 104 determines that the data replication process is not to be completed within a predefined time period, then processing proceeds to block 208. On the other hand, in another example, if data replication management module 104 determines that the data replication process is to be completed within a predefined time period, then processing proceeds to End block. In this case, in one example, data replication management module 104 sends continue notifications to target computing devices 112 to cause the target computing devices to continue with the completion of the data replication process.

At block 208, data replication management module 104 selects a target computing device 112 from the plurality of target computing devices to complete the complete the data replication process based on historical and current performance information of the plurality of target computing devices. In one example, the data replication management module selects the target computing device that has highest performance compared to those of the other target computing devices. It should be understood that the data replication management module may select the target computing device based on other techniques. Processing proceeds to block 210.

At block 210, data replication management module 104 causes the selected target computing device 112 to continue with the completion of the data replication process. In one example, data replication management module 104 sends a continue notification to the selected target computing device to cause the selected target computing device to continue with the completion of the data replication process. Processing proceeds to block 212.

At block 212, data replication management module 104 causes the non-selected target computing devices to discontinue with the data replication process. In one example, data replication management module 104 sends a discontinue notification to non-selected target computing devices 112 to cause the non-selected target computing devices to discontinue with the data replication process. Processing proceeds to block 214.

At block 214, data replication management module 104 initiates a data replication process to copy the replicated target data set to another target computing device of the plurality of target computing devices. Processing proceeds to the End block for other processing.

In this manner, the present application discloses techniques to provide data replication management techniques which may help improve data replication from a source computing device to across a plurality of target computing devices which may increase the performance of the system. For example, the data replication techniques such that even during resource constraint at least one copy of data is made to help ensure data availability.

The process 200 of FIG. 2 shows an example process and it should be understood that other configurations can be employed to practice the techniques of the present application. For example, process 200 may be configured to communicate with a plurality of computing devices 102 and the like.

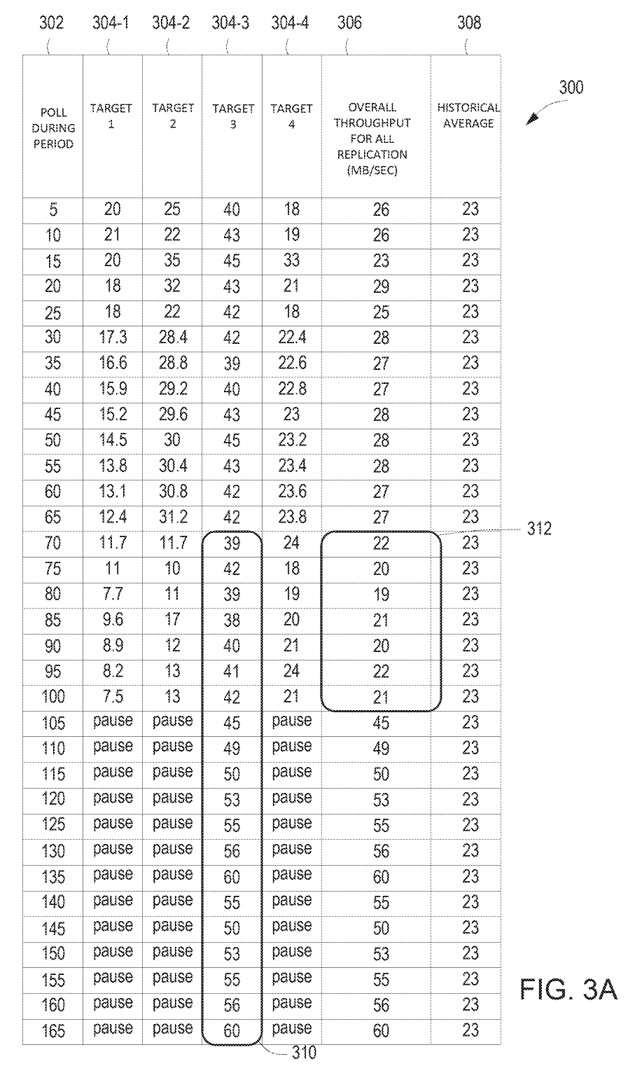

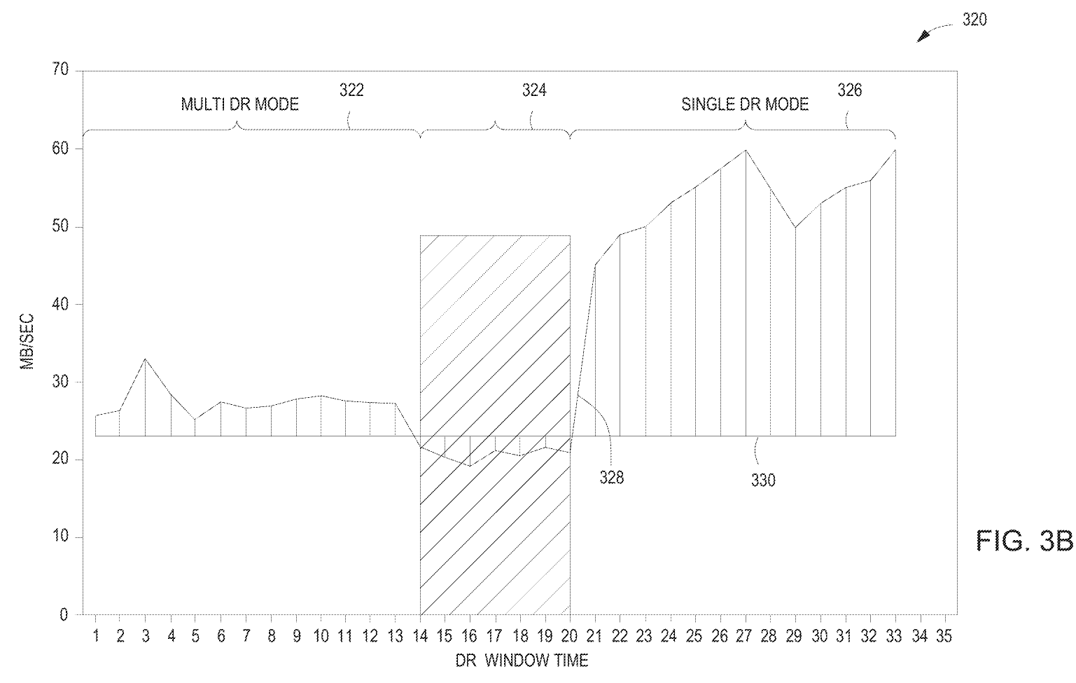

FIGS. 3A through 3B depicts example diagrams of processes for data replication management in accordance with an example of the techniques of the present application. To illustrate operation, it may be assumed that system 100 includes computing device 102 configured to communicate with target computing devices 112 over network 110. The data replication management module 104 may be configured to implement the techniques of the present application and functionality described herein.

FIG. 3A shows a table 300 to illustrate an example process of the data replication management techniques of the present application. FIG. 3B shows a graph 320 to illustrate an example process of the data replication management techniques of the present application.

Turning to FIG. 3A, to illustrate operation, in one example, it may be assumed that system 100 includes computing device 102 configured to communicate with four target computing devices 112-1, 112-2, 112-3, 112-4 over network 110. The data replication management module 104 may be configured to implement the techniques of the present application and functionality described herein.

In this example, data replication management module 104 of computing devices 102 may be configured to initiate a data replication process to copy source data set 108 as target data sets 114-1, 114-2, 114-3, 114-4 associated with respective target computing devices 112-1, 112-2, 112-3, 112-4 during a predefined time period of 200 minutes. In one example, management module 104 may be configured to receive from a host computer a request to initiate the data replication process. The management module 104 determines progress information regarding completion of the data replication process based on historical and current performance information of target computing devices 112-1, 112-2, 112-3, 112-4. In this case, management module 104 determines progress by polling the progress in 5 minutes intervals during the time period or window starting from time=5 to time=165 minutes, as shown by column 302 of table 300.

The data replication management module 104 determines the performance information of target computing devices 112-1, 112-2, 112-3, 112-4. For example, management module 104 determines current performance information of target computing devices 112-1, 112-2, 112-3, 112-4 as shown by respective current performance information columns 304-1, 304-2, 304-3, 304-4 of table 300. In this case, current performance information relates to data throughput between computing device 102 and each of target computing devices 112-1, 112-2, 112-3, 112-4.

The data replication management module 104 determines the overall progress information. In this case, management module 104 determines the current prorated performance information for all of the target computing devices, as shown by column 306 of table 300. In this case, the current performance information relates to the current data replication process.

The data replication management module 104 determines the historical performance information as shown by column 308 of table 300. In this case, the historical performance information relates to the average historical data throughput of past or previous data replication processes.

The data management module 104 determines progress information based on current and historical performance information of target computing devices 112-1, 112-2, 112-3, 112-4. In this case, in one example, management module 104 determines or calculates progress information based on current performance information of target computing devices 112-1, 112-2, 112-3, 112-4 as shown by respective columns 304-1, 304-2, 304-3, 304-4 of table 300. In this case, in one example, management module 104 determines or calculates progress information based on average historical information of target computing devices 112-1, 112-2, 112-3, 112-4 as shown by column 308 of table 300.

The data management module 104 determines whether the progress information indicates that the data replication process is not to be completed within the predefined time period.

If data management module 104 determines that the progress information indicates that the data replication process is not to be completed within the predefined time period, then management module may select a target computing device 112 from plurality of target computing devices 112-1, 112-2, 112-3, 112-4 to complete the complete the data replication process based on historical and current performance information of the plurality of target computing devices. In one example, the data replication management module selects the target computing device that has highest performance compared to those of the other target computing devices. It should be understood that the data replication management module may select the target computing device based on other techniques

On the other hand, if data replication management module 104 determines that the progress information indicates that the data replication process is to be completed within the predefined time period, then the module may send continue notifications to target computing devices 112-1, 112-2, 112-3, 112-4 to cause the target computing device to continue with the completion of the data replication process.

In this case, at time=70 minutes (column 302), data replication management module 104 determines that the overall prorated progress information (column 306) is decreasing to a value that is below the value of the historical performance information (column 308), also as shown by reference 312. For example, the historical performance information (column 308) indicates a value of 23 Mbps while the overall performance (column 306) decreased to 22 Mbps (at time=70). If the current configuration where to continue, then it may be that the replication process may not complete successfully resulting in no copies of the source data being made to target computing devices. In this case, data replication management module 104 determines that that it is time to select a target computing device 112 from plurality of target computing devices 112-1, 112-2, 112-3, 112-4 to complete the replication process.

In this case, data replication management module 104 determines that the progress information indicates that the data replication process is not to be completed within the predefined time period, then the management module selects a target computing device 112 from plurality of target computing devices 112-1, 112-2, 112-3, 112-4 to complete the complete the data replication process based on historical and current performance information of the plurality of target computing devices. In this case, management module 104 selects the third target computing device 112-3 since it has the highest performance as shown by data throughput of column 304-3 (value of 39 Mbps) of table 300 compared to those of the other target computing devices 112-1, 112-2, 112-4. The management module 104 sends a continue notification to the selected target computing device 112-3 to cause the selected target computing device to continue with the completion of the data replication process, as shown by reference 310 of table 300. In one example, management module 104 may be configured to release processing resources used by the computing device 102 associated with the non-selected target computing devices 112-1, 112-2 and 112-4 for use by the computing device for the data replication process of the selected target computing device 112-3. In this manner, releasing resources may allow the computing device to use the resources to complete replication process with the selected target computing device. In this case, the release of resources may allow computing device 102 to focus on the replication process directed to the selected target computing device 112-3 to increase performance (data throughput) from 39 Mbps (at time=70) to 60 Mbps (at time=165) as shown by reference 310 at table 300. In addition, the system takes some time to adjust the overall performance (data throughput) shown by reference 312 such that thereafter performance increases from 45 Mbps (at time=105) to 60 Mbps (at time=165) as shown by column 306 at table 300.

In this case, management module 104 send a discontinue notification to non-selected target computing devices 112-1, 112-2, 112-4 to cause the non-selected target computing devices to discontinue with the data replication process. This is illustrated by the “pause” indication in respective columns 304-1, 304-2, 304-4 of table 300 associated with respective computing devices 112-1, 112-2, 112-4.

In one example, data replication management module 104 may cause the selected target computing device 112-3 to initiate a data replication process to copy the replicated target data set to another target computing device of the plurality of target computing devices. For example, after target computing device 112-3 completes the data replication process, it may initiate a data replication process with target computing devices 11-2.

In this manner, the present application discloses techniques to provide data replication management techniques which may help improve data replication from a source computing device to across a plurality of target computing devices which may increase the performance of the system. For example, the data replication techniques such that even during resource constraint at least one copy of data is made to help ensure data availability.

Turning to FIG. 3B, graph 320 illustrates an example process of the data replication process of FIG. 3A. The graph 320 shows time on the x axis (horizontal) in time intervals and data throughput on the y axis (vertical) in Mbps. The graph 320 shows that during the initial time period, data replication management module 104 is performing a data replication process that includes all of the target computing devices 112-1, 112-2, 112-3, 112-4 as shown by reference 322. In this case, initially, the system may be said to be operating in a multiple data replication mode such that all targeting computing devices are configured to perform the data replication process, as shown by period 322 of graph 320.

However, during the next time interval, data replication management module 104 determines that the current performance is decreasing below the historical performance information during the interval (data replication window time) as shown by reference 324 of graph 320. In particular, the current performance is shown by reference 328 while the historical performance is shown as a value of 23 Mbps by reference 330 at graph 320.

In this case, data replication management module 104 selects target computing device 112-3 since it has the highest performance as represented by the highest data throughput. The management module 104 sends a continue notification to the selected target computing device 112-3 to cause the selected target computing device to continue with the completion of the data replication process, as shown by reference 326 of graph 320. In one example, the data replication management module selects the target computing device that has highest performance compared to those of the other target computing devices. It should be understood that the data replication management module may select the target computing device based on other techniques. In this case, the system is said to be operating in a single data replication mode such that only one target computing device is performing the replication process. The management module 104 sends a discontinue notification to non-selected target computing devices 112-1, 112-2, 112-4 to cause the non-selected target computing devices to discontinue with the data replication process. This allows the current performance or data throughput of the selected target computing device 112-3 for the data replication process to increase after the selection process as shown by reference 328 of graph 320. The current performance shown by reference 328 is higher and increases over the historical performance after the selection process as shown by reference 330 of graph 320.

In this manner, the present application discloses techniques to provide data replication management techniques which may help improve data replication from a source computing device to across a plurality of target computing devices which may increase the performance of the system. For example, the data replication techniques such that even during resource constraint at least one copy of data is made to help ensure data availability.

The process of FIGS. 3A and 3B shows example processes and it should be understood that other configurations can be employed to practice the techniques of the present application. For example, processes above may be configured to communicate with a plurality of computing devices communicating with target computing devices.

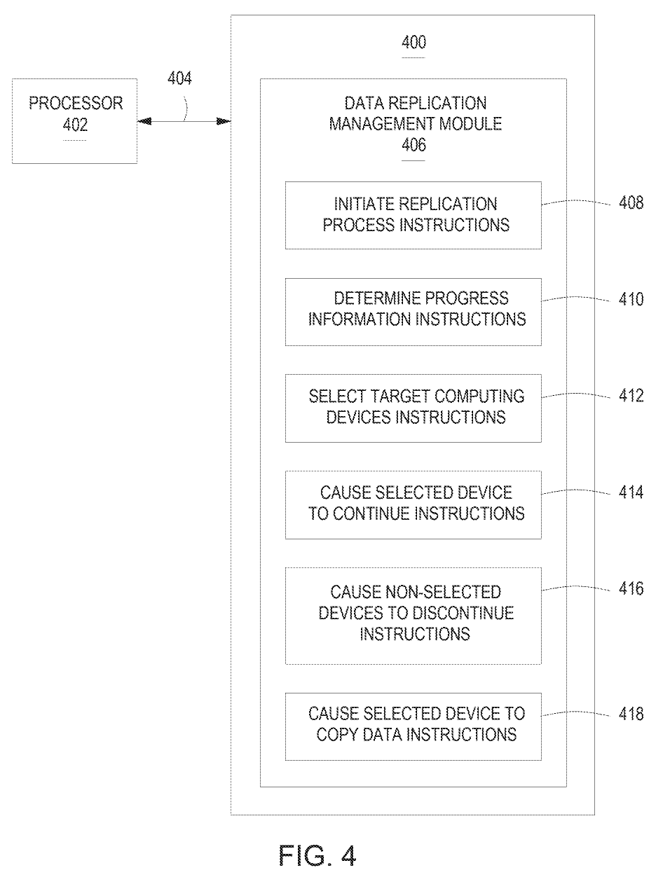

FIG. 4 is an example block diagram showing a non-transitory, computer-readable medium that stores code for operation in accordance with an example of the techniques of the present application. The non-transitory, computer-readable medium is generally referred to by the reference number 400 and may be included in the system in relation to FIG. 1. The non-transitory, computer-readable medium 400 may correspond to any typical storage device that stores computer-implemented instructions, such as programming code or the like. For example, the non-transitory, computer-readable medium 400 may include one or more of a non-volatile memory, a volatile memory, and/or one or more storage devices. Examples of non-volatile memory include, but are not limited to, electrically erasable programmable Read Only Memory (EEPROM) and Read Only Memory (ROM). Examples of volatile memory include, but are not limited to, Static Random Access Memory (SRAM), and dynamic Random Access Memory (DRAM). Examples of storage devices include, but are not limited to, hard disk drives, compact disc drives, digital versatile disc drives, optical drives, and flash memory devices.

A processor 402 generally retrieves and executes the instructions stored in the non-transitory, computer-readable medium 400 to operate the present techniques in accordance with an example. In one example, the tangible, computer-readable medium 400 can be accessed by the processor 402 over a bus 404. A first region 406 of the non-transitory, computer-readable medium 400 may include data replication management module 104 functionality as described herein. The data replication management module 104 functionality may be implemented in hardware, software or a combination thereof.

For example, block 408 provides instructions which may include instructions to initiate a data replication process, as described herein. In one example, the instructions may include instructions to initiate a data replication process to copy the source data set as target data sets to a plurality of target computing devices during a predefined time period, as described herein.

For example, block 410 provides instructions which may include instructions to determine progress information, as described herein. In one example, the instructions may include instructions to determine progress information regarding completion of the data replication process based on historical and current performance information of the plurality of target computing devices, as described herein.

For example, block 412 provides instructions which may include instructions to select a target computing, as described herein. In one example, the instructions may include instructions to select a target computing device from the plurality of target computing devices to complete the complete the data replication process based on historical and current performance information of the plurality of target computing devices, as described herein.

For example, block 414 provides instructions which may include instructions to cause the selected target computing device to continue, as described herein. In one example, the instructions may include instructions to cause the selected target computing device to continue with the completion of the data replication process, as described herein.

For example, block 416 provides instructions which may include instructions to cause the non-selected target computing devices to discontinue, as described herein. In one example, the instructions may include instructions to cause the non-selected target computing devices to discontinue with the data replication process, as described herein.

For example, block 418 provides instructions which may include instructions to cause the selected device to copy data, as described herein. In one example, the instructions may include instructions to cause the replicated target data set to be copied to another target computing device of the plurality of target computing devices, as described herein.

Although shown as contiguous blocks, the software components can be stored in any order or configuration. For example, if the non-transitory, computer-readable medium 400 is a hard drive, the software components can be stored in non-contiguous, or even overlapping, sectors.

As used herein, a “processor” may include processor resources such as at least one of a Central Processing Unit (CPU), a semiconductor-based microprocessor, a Graphics Processing Unit (GPU), a Field-Programmable Gate Array (FPGA) configured to retrieve and execute instructions, other electronic circuitry suitable for the retrieval and execution instructions stored on a computer-readable medium, or a combination thereof. The processor fetches, decodes, and executes instructions stored on medium 400 to perform the functionalities described below. In other examples, the functionalities of any of the instructions of medium 400 may be implemented in the form of electronic circuitry, in the form of executable instructions encoded on a computer-readable storage medium, or a combination thereof.

As used herein, a “computer-readable medium” may be any electronic, magnetic, optical, or other physical storage apparatus to contain or store information such as executable instructions, data, and the like. For example, any computer-readable storage medium described herein may be any of Random Access Memory (RAM), volatile memory, non-volatile memory, flash memory, a storage drive (e.g., a hard drive), a solid state drive, any type of storage disc (e.g., a compact disc, a DVD, etc.). and the like, or a combination thereof. Further, any computer-readable medium described herein may be non-transitory. In examples described herein, a computer-readable medium or media is part of an article (or article of manufacture). An article or article of manufacture may refer to any manufactured single component or multiple components. The medium may be located either in the system executing the computer-readable instructions, or remote from but accessible to the system (e.g., via a computer network) for execution. In the example of FIG. 4, medium 400 may be implemented by one computer-readable medium, or multiple computer-readable media.

In examples described herein, computing device 102 may communicate with components implemented on separate devices or system(s) via a network interface device of the computing device. For example, computing device 102 may communicate with storage device 106 via a network interface device of the computing device 102. In another example, computing device 102 may communicate with target computing devices 112 via a network interface device of the computing device 102. In examples described herein, a “network interface device” may be a hardware device to communicate over at least one computer network. In some examples, a network interface may be a Network Interface Card (NIC) or the like. As used herein, a computer network may include, for example, a Local Area Network (LAN), a Wireless Local Area Network (WLAN), a Virtual Private Network (VPN), the Internet, or the like, or a combination thereof. In some examples, a computer network may include a telephone network (e.g., a cellular telephone network).

In some examples, instructions 408-418 may be part of an installation package that, when installed, may be executed by processor 402 to implement the functionalities described herein in relation to instructions 408-418. In such examples, medium 400 may be a portable medium, such as a CD, DVD, or flash drive, or a memory maintained by a server from which the installation package can be downloaded and installed. In other examples, instructions 408-418 may be part of an application, applications, or component(s) already installed on computing device 102 including processor 402. In such examples, the medium 400 may include memory such as a hard drive, solid state drive, or the like. In some examples, functionalities described herein in relation to FIGS. 1 through 4 may be provided in combination with functionalities described herein in relation to any of FIGS. 1 through 4.

The foregoing describes a novel and previously unforeseen approach for storage management. While the above application has been shown and described with reference to the foregoing examples, it should be understood that other forms, details, and implementations may be made without departing from the spirit and scope of this application.

What is claimed is:

1. A computing device comprising:
a storage device to store a source data set; and
a data replication management module to:
initiate a data replication process to copy the source data set as target data sets to a plurality of target computing devices during a predefined time period,
determine progress information regarding completion of the data replication process based on historical and current performance information of the plurality of target computing devices,
if the progress information indicates that the data replication process is not to be completed within the predefined time period, then
select a target computing device from the plurality of target computing devices to complete the complete the data replication process based on historical and current performance information of the plurality of target computing devices, and
send a continue notification to the selected target computing device to cause the selected target computing device to continue with the completion of the data replication process,
send a discontinue notification to non-selected target computing devices to cause the non-selected target computing devices to discontinue with the data replication process, and
cause the selected target computing device to initiate a data replication process to copy the replicated target data set to another target computing device of the plurality of target computing devices.

2. The computing device of claim 1, wherein if the progress information indicates that the data replication process is to be completed within the predefined time period, then send continue notifications to the target computing devices to cause the target computing device to continue with the completion of the data replication process.

3. The computing device of 1, wherein the data replication management module to calculate the current performance information of a target computing device which relates to data throughput during the data replication process and calculate the historical performance information of the target computing device which relates to data throughput during previous data replication processes.

4. The computing device of claim 1, wherein the data replication management module to release processing resources used by the computing device associated with the non-selected target computing devices for use by the computing device for the data replication process of the selected target computing device.

5. The computing device of claim 1, wherein the data replication management module to receive from a host computer a request to initiate the data replication process.

6. A method of data replication management, the method comprising:
initiating a data replication process to copy source data set as target data sets to a plurality of target computing devices during a predefined time period;
determining progress information regarding completion of the data replication process based on historical and current performance information of the plurality of target computing devices; and
if the progress information indicates that the data replication process is not to be completed within a predefined time period, then
selecting a target computing device from the plurality of target computing devices to complete the complete the data replication process based on historical and current performance information of the plurality of target computing devices, and
causing the selected target computing device to continue with the completion of the data replication process, causing the non-selected target computing devices to discontinue with the data replication process, and causing the replicated target data set to be copied to another target computing device of the plurality of target computing devices.

7. The method of claim 6, wherein if the progress information indicates that the data replication process is to be completed within the predefined time period, then sending continue notifications to the target computing devices to cause the target computing device to continue with the completion of the data replication process.

8. The method of claim 6, further comprising calculating the current performance information of a target computing device which relates to data throughput during the data replication process and calculating the historical performance information of the target computing device which relates to data throughput during previous data replication processes.

9. The method of claim 6, further comprising releasing processing resources used by the computing device associated with the non-selected target computing devices for use by the computing device for the data replication process of the selected target computing device.

10. The method of claim 6, further comprising receiving from a host computer a request to initiate the data replication process.

11. A non-transitory computer-readable medium having computer executable instructions stored thereon for data replication management, the instructions are executable by a processor to:
initiate a data replication process to copy source data set as target data sets to a plurality of target computing devices during a predefined time period;
determine progress information regarding completion of the data replication process based on historical and current performance information of the plurality of target computing devices; and
if the progress information indicates that the data replication process is not to be completed within a predefined time period, then
select a target computing device from the plurality of target computing devices to complete the complete the data replication process based on historical and current performance information of the plurality of target computing devices, and
cause the selected target computing device to continue with the completion of the data replication process, cause the replicated target data set to be copied to another target computing device of the plurality of target computing devices, and cause the non-selected target computing devices to discontinue with the data replication process.

12. The non-transitory computer-readable medium of claim 11, further comprising instructions that if executed cause a processor to: send a discontinue notification to non-selected target computing devices to cause the non-selected target computing devices to discontinue with the data replication process.

13. The non-transitory computer-readable medium of claim 11, further comprising instructions that if executed cause a processor to: calculate the current performance information of a target computing device which relates to data throughput during the data replication process and calculate the historical performance information of the target computing device which relates to data throughput during previous data replication processes.

14. The non-transitory computer-readable medium of claim 11 further comprising instructions that if executed cause a processor to: release processing resources used by the computing device associated with the non-selected target computing devices for use by the computing device for the data replication process of the selected target computing device.

15. The non-transitory computer-readable medium of claim 11 further comprising instructions that if executed cause a processor to: receive from a host computer a request to initiate the data replication process.
